(19) United States
(12) Patent Application Publication
(10) Pub. No.: US 2006/0035600 A1
(43) Pub. Date: Feb. 16, 2006

(54) RF front-end apparatus in a TDD wireless communication system

(75) Inventors: Dong-Geun Lee, Koyang-si (KR); Young-Jin An, Yongin-si (KR); Kweon Na, Yongin-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/191,516

(22) Filed: Jul. 28, 2005

(30) Foreign Application Priority Data
Jul. 28, 2004 (KR) 2004-0059048
Aug. 13, 2004 (KR) 2004-0064148

(51) Int. Cl. H04B 7/14; H04B 1/44

(52) U.S. Cl. 455/78; 455/24

(57) ABSTRACT

An RF front-end apparatus in a TDD wireless communication system is provided. In the RF front-end apparatus, a detector is provided at a predetermined position in a signal path, and detects a signal propagating in the signal path. A circulator provides a signal received from a power amplifier to an antenna feed line and a signal received from the antenna feed line to a switch. A switch controller generates a control signal based on the signal received from the detector and a switch on/off signal received from a control board. The switch, which is disposed at an input port of an LNA, switches on/off according to the control signal received from the switch controller.

### PRIORITY

This application claims priority under 35 U.S.C. § 119 to applications entitled “RF Front-End Apparatus In A TDD Wireless Communication System” filed in the Korean Intellectual Property Office on Jul. 28, 2004 and assigned Serial No. 2004-59048 and “RF Front-End Apparatus In A TDD Wireless Communication System” filed in the Korean Intellectual Property Office on Aug. 16, 2004 and assigned Serial No. 2004-64148 the contents of which are incorporated herein by reference.

### BACKGROUND OF THE INVENTION

1. Field of the Invention

The present invention relates generally to a radio frequency (RF) front-end apparatus in a time division duplex (TDD) wireless communication system, and in particular, to an apparatus for protecting a low noise amplifier (LNA) at a receiver side.

2. Description of the Related Art

In a TDD wireless communication system that seeks to efficiently use radio resources by efficient time distribution on the uplink and the downlink, an RF front-end apparatus is implemented using either an RF switch alone, or using a circulator and an RF switch in combination.

FIG. 1 illustrates an RF front-end apparatus using an RF switch.

Referring to FIG. 1, the output port of a transmitter 101 is connected to a power amplifier (PA) 102, and the output port of an LNA 104 is connected to a receiver 103. A single-pole double-throw (SPDT) switch (S/W) 105 switches a transmission (Tx) signal from the PA 102 to a filter 106 in a transmission operation, and switches a received (Rx) signal from the filter 106 to the LNA 104 in a reception operation. The filter 106 band-pass-filters the Tx signal and the Rx signal. Meanwhile, a directional coupler (D/C) 107, which is connected between the filter 106 and an antenna, couples the Tx signal and the Rx signal. The coupled signals are used to monitor abnormalities in the Tx signal and the Rx signal. The RF front-end apparatus is so configured that the RF switch 105 switches between a Tx signal path and an Rx signal path according to a control signal. This RF front-end configuration is simple and thus easy to implement. Another advantage is high switch isolation even when an RF signal is not synchronized to a switch control signal, enough to transfer RF power to the LNA at or below an acceptable level. In the case of a high-power RF switch, however, it is usually utilized in a system that transmits at a power below 1 W due to its high price.

FIG. 2 illustrates the configuration of an RF front-end apparatus using a circulator and an RF switch in combination.

Referring to FIG. 2, a PA 202 is connected to the output port of a transmitter 201 and a receiver 203 is connected to the output port of an LNA 204. A circulator 205 connects a Tx signal from the PA 202 to a filter 207 and connects an Rx signal from the filter 207 to the LNA 204 through switch 206. The filter 207 band-pass-filters the Tx signal and the Rx signal. Meanwhile, a D/C 208 is connected between the filter 207 and an antenna, for coupling the Tx signal and the Rx signal. The coupled signals are used to monitor abnormalities in the Tx signal and the Rx signal. Switch 206, which is connected between the LNA 204 and the circulator 205, connects or disconnects the circulator 205 to or from the LNA 204 according to a control signal from a control board (not shown). The RF front-end apparatus separates the transmission path from the reception path, relying on the principle that the downlink experiences minimal signal attenuation and the uplink suffers great signal propagation loss. If some problem occurs in an antenna feed line, the reflected power of transmit power can be introduced into the LNA, causing permanent damage to the input end circuit of the LNA. This RF front-end configuration finds its applications in a system that transmits at a power below several watts (e.g. 7 to 8 W).

While these RF front-end apparatuses having the configurations illustrated in FIGS. 1 and 2 can be applied to a TDD system using low-power RF signals, they are not viable in a system using high-power RF signals (at or above about 10 W) due to the power rating and breakdown of parts and cost ineffectiveness in circuit implementation. In particular, implementation of an RF front-end apparatus to handle high power in the manner illustrated in FIG. 1 requires an unrealistic expense (near $1,500). In addition, while the RF front-end apparatus illustrated in FIG. 2 is capable of processing up to medium power, problems with an antenna feed line may cause reflection of transmit power into the input port of the LNA, resulting in fatal damage to the input circuit of the LNA.

In addition, the RF front-end configuration using a circulator and a low-power RF switch illustrated in FIG. 2 can cause great damage to the LNA at the rear end of the low-power switch in the case where an RF signal(Tx signal) discords with a low-power RF switch control signal. For example, when 60 W transmit power typically used in a base station (BS) is introduced into the circulator and an error of the control signal switches on the RF switch, power of about 20 dBm or above is transferred to the LNA, thus destroying the LNA.

As described above, the introduction of a Tx signal or its reflected wave (or standing wave) into an LNA may cause a permanent damage to the LNA in a TDD system. As the TDD system outputs higher transmit power, a receiving side is more severely damaged. Accordingly, a need exists for a protection circuit for minimizing damage at the receiving side. One approach can be to use a limiter that limits high power at the receiving side. However, this method suffers from insertion loss in a steady state, thereby decreasing noise figure (NF) performance. Also, it increases material costs in the BS.

### SUMMARY OF THE INVENTION

An object of the present invention is to provide an RF front-end apparatus for processing a high-power RF signal in a TDD wireless communication system.

Another object of the present invention is to provide an apparatus for preventing damage to an LNA caused by discordance between a Tx signal and a control signal in a TDD wireless communication system.

A further object of the present invention is to provide an apparatus for attenuating transmit power introduced into an LNA in a TDD wireless communication system using high power.

Still another object of the present invention is to provide an apparatus for controlling a switch in an Rx signal path using a voltage standing wave ratio (VSWR) alarm in a TDD wireless communication system.

Yet another object of the present invention is to provide an apparatus for protecting an LNA by controlling a switch in an Rx signal path upon generation of a VSWR alarm in a TDD wireless communication system.

According to one aspect of the present invention, in an RF front-end apparatus in a TDD wireless communication system, a detector is provided at a predetermined position in a signal path, and detects a signal propagating in the signal path. A circulator provides a signal received from a power amplifier to an antenna feed line and a signal received from the antenna feed line to a switch. A switch controller generates a control signal based on the signal received from the detector and a switch on/off signal received from a control board. The switch, which is disposed at an input port of an LNA, switches on/off according to the control signal received from the switch controller.

It is preferred that the detector is disposed in a transmission signal path and includes a coupler in a transmission signal path, for coupling a signal propagating in the transmission signal path, and a signal detector for generating a transmission on/off signal indicating the presence or absence of a transmission signal according to the power level of the coupled signal received from the coupler and providing the transmission on/off signal to the switch controller.

It is also preferred that the detector is disposed in a signal path at a rear end of the circulator and includes a coupler for coupling a transmission signal and a received signal propagating in the signal path, and a signal detector for calculating the power ratio between the coupled transmission and received signals, comparing the power ratio with a predetermined threshold, and if determining that the received signal is the reflected wave of the transmission signal, providing a VSWR alarm signal to the switch controller.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates the configuration of an RF front-end apparatus using an RF switch;

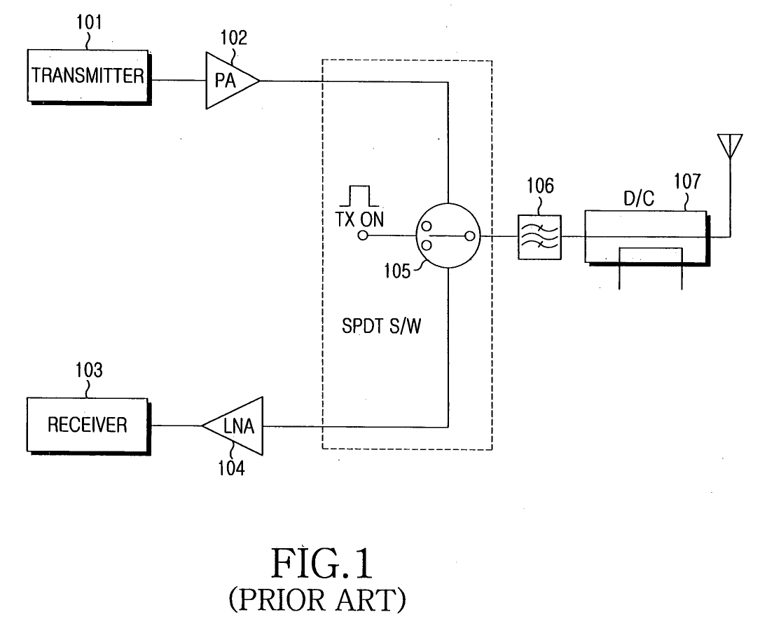

FIG. 2 illustrates the configuration of an RF front-end apparatus using a circulator and an RF switch in combination;

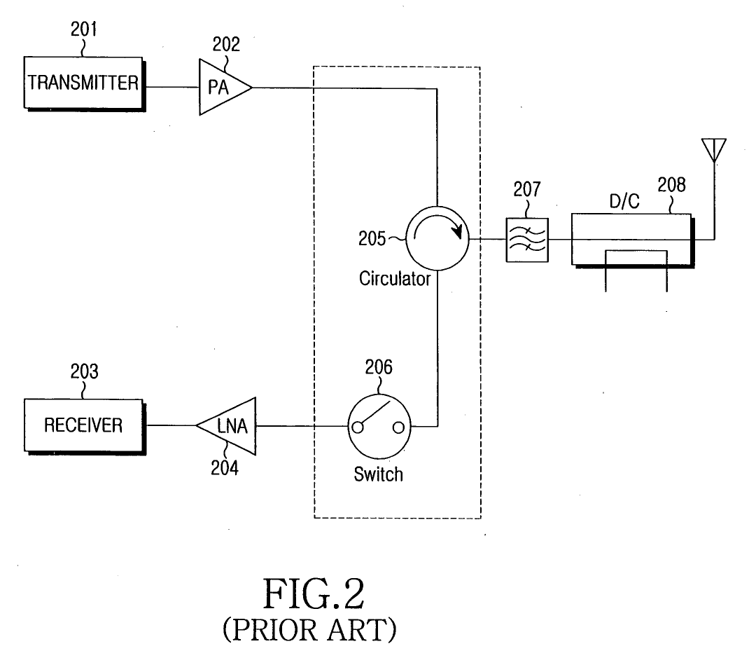

FIG. 3 is a schematic view illustrating the configuration of a control circuit for protecting an LNA according to an embodiment of the present invention;

FIG. 4 illustrates the configuration of an RF front-end apparatus in a TDD system according to an embodiment of the present invention;

FIG. 5 illustrates the configuration of an RF front-end apparatus in a TDD system according to an alternative embodiment of the present invention;

FIG. 6 is a timing diagram of a Tx signal and a switch control signal in the TDD system according to the present invention;

FIG. 7 illustrates the configuration of an RF front-end apparatus in a TDD system according to a further embodiment of the present invention;

FIG. 8 is a block diagram of a VSWR alarm generator illustrated in FIG. 7; and

FIG. 9 is a circuit diagram of a switch controller illustrated in FIG. 7.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

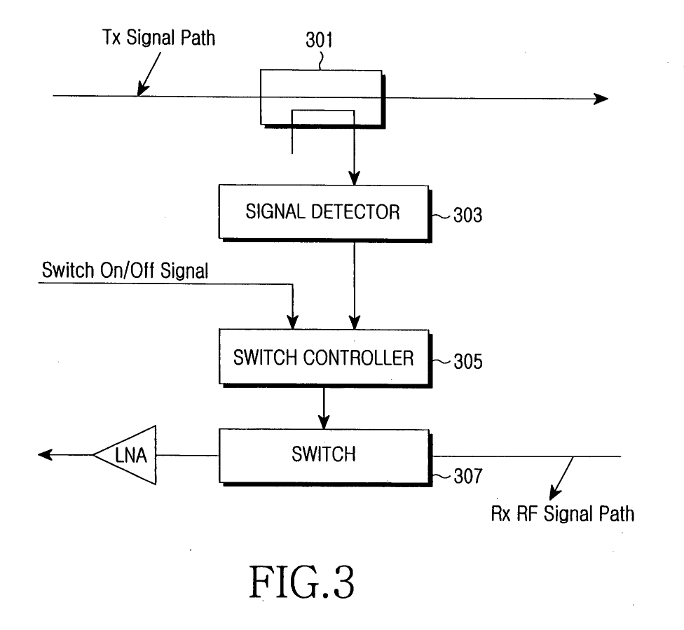

FIG. 3 is a schematic view illustrating the configuration of a control circuit for protecting an LNA according to an embodiment of the present invention. As illustrated in FIG. 3, the control circuit includes a signal coupler 301, a signal detector 303, a switch controller 305, and a switch 307. The signal coupler 301 resides in a signal path and the switch 307 is at the input end of the LNA.

Referring to FIG. 3, the signal coupler 301 couples a Tx signal or an Rx signal propagating in the signal path. The signal coupler 301 can be provided at any of a baseband end, intermediate frequency (IF) end, and an RF end. The signal detector 303 determines the presence or absence of the Tx signal based on the power level of the coupled signal received from the signal coupler 301, and outputs a High or Low signal according to the presence or absence of the Tx signal. For example, in the presence of the Tx signal, the signal detector 303 outputs a transistor-transistor logic (TTL) High signal and otherwise, a TTL Low signal. For another example, the signal detector 303 measures the power ratio between the coupled Tx signal and the coupled Rx signal, compares the power ratio with a predetermined threshold, and if the Rx signal is decided to be the reflected wave (or standing wave) of the Tx signal, generates a VSWR alarm signal.

The switch controller 305 generates a control signal to control the switch 307 based on a Switch On/Off signal received from a control board (not shown) and a Tx On/Off signal (or a VSWR alarm signal) received from the signal detector 303. The switch 307 switches on/off according to the control signal received from the switch controller 305 and correspondingly connects/blocks a signal propagated in an Rx signal path to/from the LNA. For example, upon receipt of a Switch On signal and a Tx On signal, the switch controller 305 determines the presence of a Tx signal and switches off the switch 307. As another example, upon receipt of a VSWR alarm signal, the switch controller 305 switches off the switch 307 irrespective of the Switch On/Off signal from the control board, thereby protecting a receiving side.

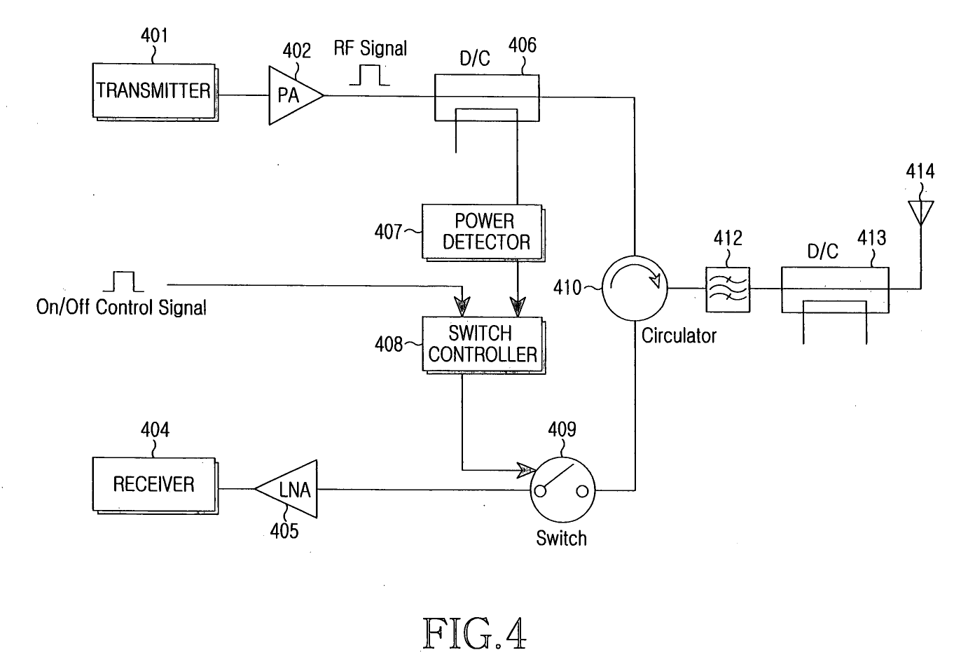

FIG. 4 illustrates the configuration of an RF front-end apparatus in a TDD system according to an embodiment of the present invention.

As illustrated in FIG. 4, the RF front-end apparatus includes a transmitter 401, a PA 402, a receiver 404, an LNA 405, a first D/C 406, a power detector 407, a switch controller 408, a switch 409, a circulator 410, a filter 412, a second D/C 413, and an antenna 414. The PA 402 amplifies the power of a Tx signal received from the transmitter 401. Typically, an isolator is provided at the output end of the PA 402, for protecting the termination circuit of the PA 402. The first D/C 406 couples the Tx signal received from the PA 402.

The circulator 410 transfers the coupled signal received from the first D/C 406 to the filter 412 and a signal received from the filter 412 to the switch 409 in the indicated direction. During this operation, the circulator 410 provides about 20 dB of signal isolation between a Tx signal path and an Rx signal path and causes about 0.3 dB of path loss between the antenna 414 and each of the Tx and Rx signal paths. The filter 412, connected between the circulator 410 and the second D/C 413, band-pass-filters the Tx signal and the Rx signal. The second D/C 413, connected between the filter 412 and the antenna 414, couples the Tx signal and the Rx signal. The coupled signals are used to monitor abnormalities in the Tx signal and the Rx signal.

The power detector 407 detects the power of the coupled signal received from the first D/C 406, determines the presence or absence of the Tx signal based on the power, and outputs a High or Low signal according to the presence or absence of the Tx signal. For example, in the presence of the Tx signal, the power detector 407 outputs a TTL High signal and otherwise, a TTL Low signal. The switch controller 408 generates a control signal to control the switch 409 based on a Switch On/Off signal received from a control board (not shown) and a Tx On/Off signal received from the power detector 407.

The switch 409 switches on/off according to the control signal received from the switch controller 408 and correspondingly connects/blocks the signal received from the circulator 410 to/from the input port of the LNA 405. The LNA 405 low-noise-amplifies the signal received from the switch 408 and outputs the amplified signal to the receiver 404. If the switch controller 408 determines the presence of RF power, it switches off the switch 409 even though receiving the Switch On signal from the control board, thereby protecting the LNA 405.

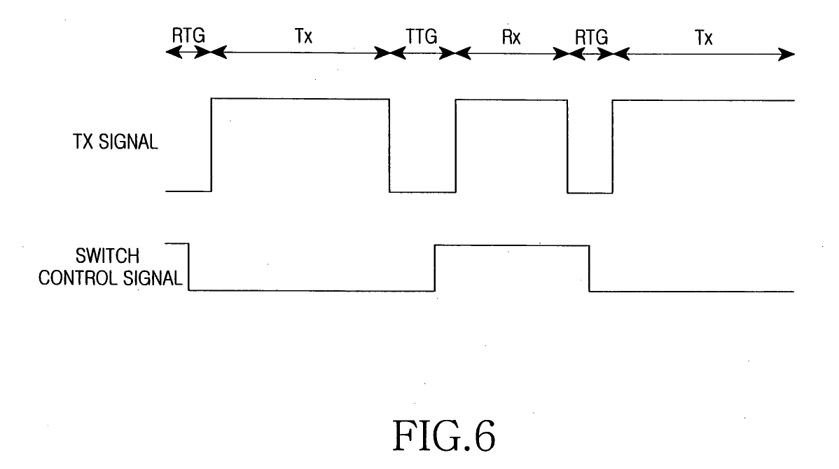

Referring to FIG. 6, the switch control signal from the control board turns off before an actual Tx period begins and turns on before an Rx period begins. If the system operates normally, the following signal combinations are available: (Tx On, Switch Off), (Tx Off, Switch On), and (TX Off, Switch Off). Because (TX Off, Switch Off) may occur in a Tx-Rx transition period TTG (Tx Transition Gap) and an Rx-Tx transition period RTG (Rx Transition Gap) as well as in an abnormal state, it will not be considered herein. That is, (TX On, Switch On) will be considered to be abnormal.

Table 1 below illustrates the operation of the switch controller 408.

TABLE 1

| Input 1 | Input 2 | | |
|---|---|---|---|
| (from power | (from control | | |
| detector) | board) | State | Output |
| TTL/High | TTL/High | Abnormal | TTL/Low |
| (TX On) | (Switch On) | (LNA damage) | (Switch Off) |
| TTL/High | TTL/Low | Normal (Tx) | TTL/Low |
| (TX On) | (Switch Off) | | (Switch Off) |
| TTL/Low | TTL/High | Normal (Rx, TTG, RTG) | TTL/High |
| (TX Oft) | (Switch On) | | (Switch On) |
| TTL/Low | TTL/Low | Abnormal (Rx | TTL/Low |
| (TX Off) | (Switch Off) | impossible) | (Switch Off) |
| | | Normal (TTG, RTG) | |

As noted from Table 1, when the Tx signal discords with the switch control signal, the switch controller 408 switches off the switch 409, thereby blocking power from being introduced into the LNA 405.

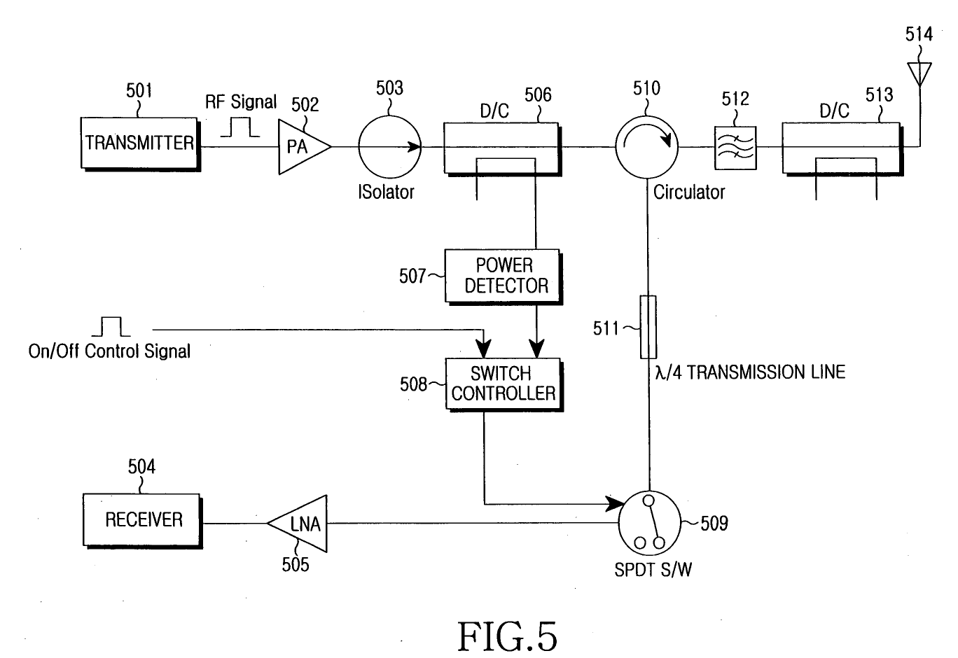

FIG. 5 illustrates the configuration of an RF front-end apparatus in a TDD system according to an alternative embodiment of the present invention.

As illustrated in FIG. 5, the RF front-end apparatus includes a transmitter 501, a PA 502, an isolator 503, a receiver 504, an LNA 505, a first D/C 506, a power detector 507, a switch controller 508, an SPDT switch 509, a circulator 510, a quarter wave (λ/4) transmission line 511, a filter 512, a second D/C 513, and an antenna 514.

Referring to FIG. 5, the PA 502 amplifies the power of a Tx signal received from the transmitter 501. The isolator 503 is a conventional isolator and is connected to the output port of the PA 502, for protecting the termination circuit of the PA 502. It also functions to terminate a reflected signal due to some defect in an antenna feed line path. The first D/C 506 couples the Tx signal received from the isolator 503.

The circulator 510 transfers the coupled signal received from the first D/C 506 to the filter 512 and a signal received from the filter 512 to the quarter wave transmission line 511 in the indicated direction. During this operation, the circulator 510 provides about 20dB of signal isolation between a Tx signal path and an Rx signal path and causes about 0.3dB of path loss between the antenna 414 and each of the Tx and Rx signal paths.

The filter 512, connected between the circulator 510 and the second D/C 513, band-pass-filters the Tx signal and the Rx signal. The second D/C 513, connected between the filter 512 and the antenna 514, couples the Tx signal and the Rx signal. The coupled signals are used to monitor abnormalities in the Tx signal and the Rx signal.

The quarter wave transmission line 511 is connected between the circulator 510 and the SPDT switch 509. The impedance seen from the circulator 510 is open (i.e. the SPDT switch 509 is grounded), or 50ω (i.e. the SPDT switch 509 is connected to the LNA 505) depending on the load state of the quarter-wave transmission line 511 (i.e. the connection state of the SPDT switch 509). In fact, if the SPDT switch 509 is grounded, the quarter-wave transmission line 511 provides a near 20-dB isolation between the circulator 510 and the SPDT switch 509.

The power detector 507 detects the power of the coupled signal received from the first D/C 506, determines the presence or absence of the Tx signal based on the power, and outputs a High or Low signal according to the presence or absence of the Tx signal. For example, in the presence of the Tx signal, the power detector 407 outputs a TTL High signal and otherwise, a TTL Low signal. The switch controller 508 generates a control signal to control the SPDT switch 509 based on a Switch On/Off signal received from a control board (not shown) and a Tx On/Off signal received from the power detector 507. The switch controller 508 operates in the manner illustrated in Table 1, thereby protecting the LNA 505 against damage caused by transmit power. For example, if the switch controller 508 determines the presence of RF power, it switches off the SPDT switch 509 even though receiving the Switch On signal from the control board, thereby protecting the LNA 505.

The SPDT switch 509 shorts the load of the quarter wave transmission line 511 to ground or connects the load of the quarter-wave transmission line 511 to the LNA 505 according to the control signal from the switch controller 508. In the former case, about 26-dB isolation is provided between the quarter-wave transmission line 511 and the LNA 505, whereas in the latter case, about 0.3 to 0.4-dB signal loss occurs. In real implementation, the SPDT switch 509 can be implemented using a PIN diode or a transistor (e.g. GaAs FET (Field Effect Transistor)).

The LNA 505 low-noise-amplifies the signal received from the SPDT switch 509 and outputs the amplified signal to the receiver 504.

Referring to FIG. 5 again, a high-power Tx signal (e.g. 60 W or so) from the PA 502 is radiated in a path running from the isolator 503 to the antenna 514 via the circulator 510, the filter 512 and the D/C 513, in this order. The SPDT switch 509 is grounded according to the control signal from the switch controller 508.

Thus, the impedance seen from one end of the quarter-wave transmission line 511 having the other end shorted (e.g. a transmission line as long as one quarter of a valid wavelength at 2.35 GHz) is open according to the transmission line theory (∝=jZ₀ tan βl, l=λ/4), thereby preventing introduction of the high-power Tx signal into the reception side. In this state, the quarter-wave transmission line 511 isolates the Tx signal by 20 dB or above. The SPDT switch 509, preferably a model UPG2009 manufactured by NEC, also isolates the Tx signal by approximately 26 dB. Eventually, the transmit power induced into the input port of the LNA 505 due to leakage from the circulator 510 amounts to −18.5 dBm, as set forth below:
−18.5 dBm=+47.8 dBm (PA output, 60 W)−0.3 dB (isolator loss)−20 dB (circulator isolation)−20 dB (λ/4 transmission line isolation)−26 dB (SPDT switch isolation).

The transmit power induced into the input port of the LNA 505, about −18 dBm is too negligible to inflict electrical damage on the input port of the LNA 505 at the reception side, compared to Input IP3 (+12 dBm) at the input port of an LNA, for example, MGA72543 of Agilent which is a type of LNA.

As described above, the RF front-end configuration illustrated in FIG. 5 is characterized in that the LNA 505 is protected by attenuating transmit power introduced into the LNA 505. Furthermore, in the case where the Tx signal discords with the switch control signal, the switch controller 508 switches off the SPDT switch 509, thereby preventing defects within the control system from damaging the LNA 505.

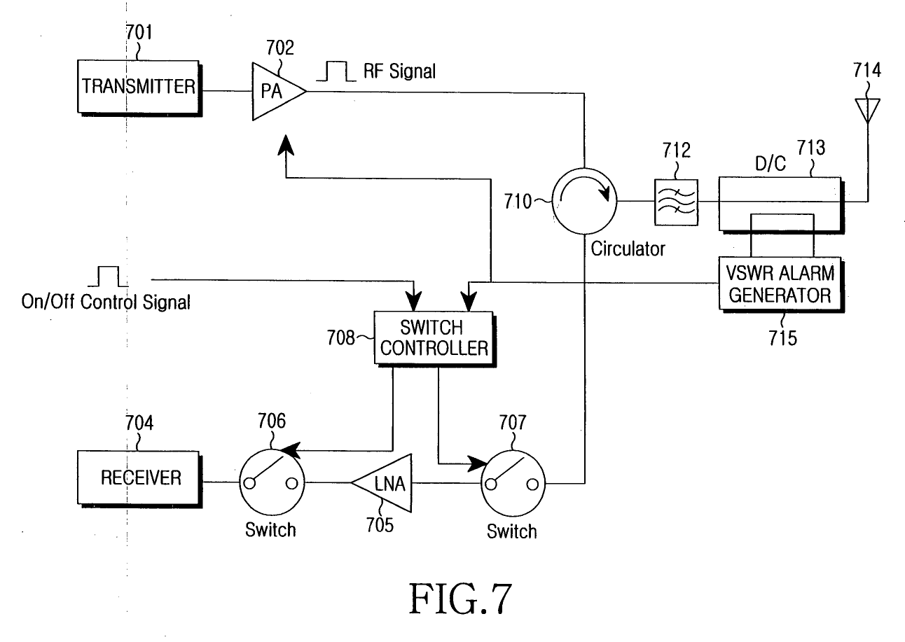

FIG. 7 illustrates the configuration of an RF front-end apparatus in a TDD system according to a further embodiment of the present invention.

As illustrated in FIG. 7, the RF front-end apparatus includes a transmitter 701, a PA 702, a receiver 704, an LNA 705, a first switch 706, a second switch 707, a switch controller 708, a circulator 710, a filter 712, a D/C 713, an antenna 714, and a VSWR alarm generator 715. The PA 702 amplifies the power of a Tx signal received from the transmitter 701. An isolator may be provided at the output end of the PA 702, for protecting the termination circuit of the PA 702.

The circulator 710 transfers the signal received from the PA 702 to the filter 712 and a signal received from the filter 712 to the second switch 707 in the indicated direction. During this operation, the circulator 710 provides about 20 dB of signal isolation between a Tx signal path and an Rx signal path and causes about 0.3 dB of path loss between the antenna 714 and each of the Tx and Rx signal paths.

The filter 712, connected between the circulator 710 and the D/C 713, band-pass-filters the Tx signal and the Rx signal. The D/C 713, connected between the filter 712 and the antenna 714, couples the Tx signal and the Rx signal. The coupled signals are provided to the VSWR alarm generator 715. A coupling value of 30 dB, for example, can be used.

The VSWR alarm generator 715 calculates the power ratio between the coupled Tx and Rx signals, compares the power ratio with a predetermined threshold, and if the Rx signal is the reflected wave (or standing wave) of the Tx signal, generates a VSWR alarm. For example, if the power ratio of the Tx signal to the Rx signal is less than 3:1, that is, if the power difference between the Tx signal and the Rx signal is below a predetermined threshold, the Rx signal is considered to be the reflected wave (or standing wave) of the Tx signal. Although the power level of a signal received from a mobile station is even lower than that of a reflected signal, a relatively stronger jamming signal can be received along with the mobile station signal. Considering this case, the ratio of the Tx signal to the Rx signal is set to 3:1 as a criterion to generate a VSWR alarm.

The second switch 707 switches on/off according to a control signal received from the switch controller 708 and correspondingly connects/blocks the signal received from the circulator 710 to/from the input port of the LNA 705. While not shown, a quarter wave transmission line can be provided between the second switch 707 and the circulator 710. The LNA 705 low-noise-amplifies the signal received from the second switch 707 and outputs the amplified signal to the receiver 704 through the first switch 706. The first switch 706 switches on/off according to the control signal received from the switch controller 708 and correspondingly connects/blocks the signal received from the LNA 705 to/from the receiver 704. The first and second switches 706 and 707 are RF switches such as single-pole single throw (SPST) switches as illustrated in FIG. 7, or can be SPDT switches. In real implementation, the RF switches can be configured using PIN diodes. The use of the two switches 706 and 707 ensures double protection for the receiving side. The second switch 707 primarily blocks the introduction of transmit power into the receiving side and the first switch 706 secondarily blocks the introduction of the transmit power into the receiving side.

The switch controller 708 generates the control signal for controlling the switches 706 and 707 based on a Switch On/Off signal received from a control board (not shown) and the VSWR alarm signal received form the VSWR alarm generator 715.

The switch controller 708 protects the LNA 705 against damage caused by transmit power which is reflected due to defects with an antenna feed line by operating in the manner illustrated in Table 2 below.

TABLE 2

| Control input | | | | | |
|---|---|---|---|---|---|
| | | 1^{st} switch | | | |
| VSWR | Switch | control | | Signal | |
| Alarm | On/Off | signal | 2^{nd} switch | path state | |
| VSWR_{—} | signal | (Switch_{—} | control signal | Main | |
| ARM) | (clk_TDD) | ctl_A) | (Switch_ctl_B) | path | Ground |
| High | Low | High | Low | Off | On |
| High | High | High | Low | Off | On |
| Low | Low | High | Low | Off | On |
| Low | High | Low | High | On | Off |

As shown in Table 2, the switch controller 708 connects the switches 706 and 707 to a main path (Main path-On) only in the case of no VSWR alarm from the VSWR alarm generator 715 and a Switch On signal from the control board. Otherwise, the switch controller 708 connects the switches 706 and 707 to ground (Ground-On). That is, in an abnormal state (upon generation of a VSWR alarm), the switch controller 708 forcibly protects the LNA 705 irrespective of the Switch On/Off signal from the control board. In the illustrated case of Table 2, the switches operate for the input of two control signals, by way of example.

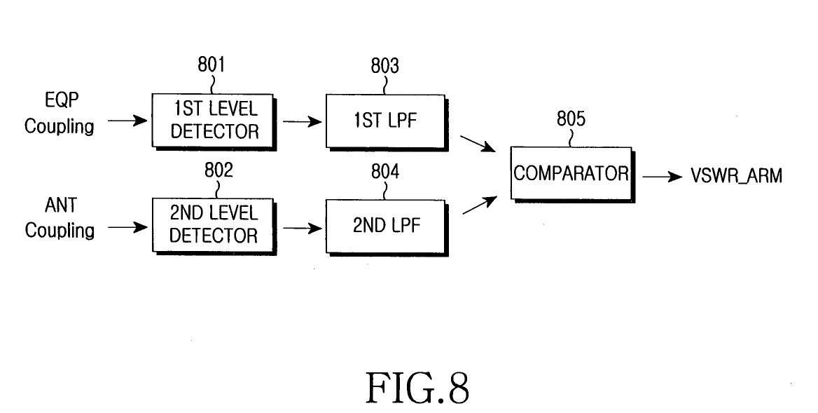

Referring to FIG. 8, the VSWR alarm generator 715 will be described. VSWR alarm generator 715 includes a first level detector 801, a second level detector 802, a first low-pass filter (LPF) 803, a second LPF 804, and a comparator 805.

In operation, the first level detector 801 detects the power level of a Tx signal coupled in the D/C 713 (EQuiPment coupling signal). The second level detector 802 detects the power level of an Rx signal coupled in the D/C 713 (ANTenna coupling signal). The first LPF 803 eliminates noise from the signal received from the first level detector 801 by low-pass filtering.

The comparator 805 calculates the power ratio between the signals from the first and second LPFs 803 and 804, compares the power ratio with a predetermined threshold, and if it determines that the Rx signal is the reflected wave (or standing wave) of the Tx signal, outputs a VSWR alarm (High) signal to the switch controller 708.

A measuring period or a signal detection time period must be set to at least one period of Tx and Rx, referring to FIG. 6. If signal detection is carried out in synchronization to the Tx signal, a time delay at the rear end of the PA is several nano seconds and thus the reflected signal mostly appears in the Tx period. Therefore, a signal is detected only in the Tx period. However, without synchronization, if a signal is detected in a shorter measuring period and the measuring period coincides with an Rx period, the antenna coupling signal (i.e. Rx signal) is greater than the equipment coupling signal (i.e. Tx signal) in power, resulting in a VSWR alarm. Accordingly, it is preferable to detect a signal in at least one Tx and Rx period.

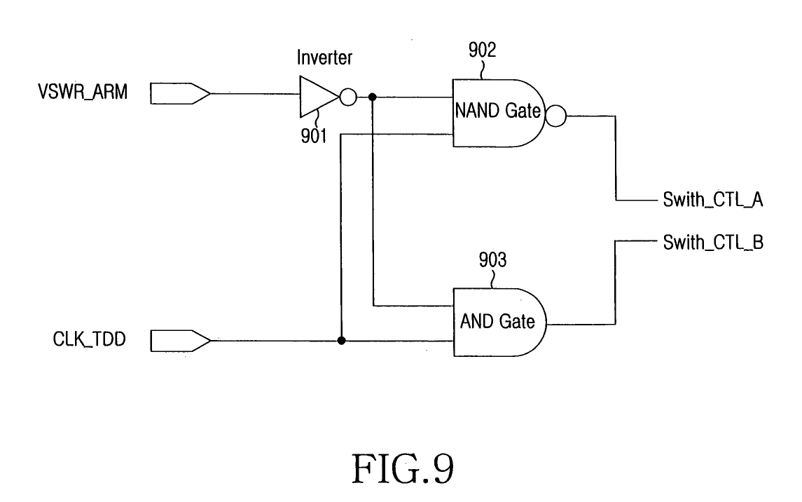

A description of the switch controller 708 is set forth with reference to FIG. 9. The switch controller 708 includes an inverter 901, a first logic gate 902, and a second logic gate 903.

In operation, the inverter 901 inverts a signal received from the VSWR alarm generator 715. The first logic gate 902 NAND-operates the inverted signal with a Switch On/Off signal (CLK_TDD) received from the control board. The NAND signal is a first switch control signal (Switch_ctl_A) illustrated in Table 3.

Meanwhile, the second logic gate 903 AND-operates the inverted signal with the Switch On/Off signal received from the control board. The AND signal is a second switch control signal (Switch_ctl_B) illustrated in Table 3. In this way, the switches 706 and 707 operate for the input of two control signals according to the embodiments of the present invention.

The configuration of the switch controller 708 illustrated in FIG. 9 is an exemplary application. In real implementation, it is preferred to replace the logic gates with programmable logic devices. For example, electronic programmable logic devices (EPLDs) can be implemented by means of a very high speed integrated circuits hardware description language (VHDL). This method is more efficient than hardware implementation in terms of material cost and space utilization. Furthermore, in the case of adding functions, the configuration of the switch controller 708 can be modified in software without hardware modifications, which is easier than circuit modifications.

Table 3 below illustrates a VHDL source for actual EPLD implementation. The VHDL source was designed to control two individual Rx signal paths (Path A and Path B) with diversity.

TABLE 3

Switch A Control (Switch Control in Rx Path A)

process(vswr_alm_a,clk_tdd_a)
begin

if vswr_alm_a=‘0’ and clk_tdd_a=‘1’ then

switch_ctl_a2<=‘1’;

switch_ctl_a1<=‘0’;

else

switch_ctl_a2<=‘0’;

switch_ctl_a1<=‘1’;

end if;

end process;

Switch B Control (Switch Control in Rx Path B)

process(vswr_alm_b,clk_tdd_b)
begin

if vswr_alm_b=‘0’ and clk_tdd_b=‘1’ then

switch_ctl_b2<=‘1’;

switch_ctl_b1<=‘0’;

else

switch_ctl_b2<=‘0’;

switch_ctl_b1<=‘1’;

end if;

end process;

As noted from Table 3, a switch in an Rx signal path is controlled to be connected to an LNA only if a Switch On/Off signal (clk_tdd) is 1 (High) in a normal state, that is, without vswr_alm in the present invention.

In accordance with the present invention as described above, an LNA is protected against discordance between a Tx signal and a switch control signal, caused by abnormalities such as errors in board insertion/detachment and in control signal generation in a TDD wireless communication system. Also, a receiving side (the LNA) is protected against transmit power reflected due to defects with an antenna feed line. Particularly, in applying the present invention to an RF front-end in a high speed portable Internet (HPI) system, which is currently under development, technical problems involved in TDD operation of high-power signals can be easily addressed.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A radio frequency (RF) front-end apparatus in a time division duplex (TDD) wireless communication system, comprising:
a detector at a predetermined position in a signal path, for detecting a signal propagating in the signal path;
a circulator for providing a signal received from a power amplifier to an antenna feed line and a signal received from the antenna feed line to a switch;
a switch controller for generating a control signal based on the signal received from the detector and a switch on/off signal received from a control board; and
the switch positioned at an input port of a low-noise amplifier (LNA), for switching on/off according to the control signal received from the switch controller.

2. The RF front-end apparatus of claim 1, further comprising a quarter wave transmission line connected between the circulator and the switch.

3. The RF front-end apparatus of claim 1, further comprising an isolator for protecting an output port of the power amplifier and terminating a signal reflected due to a defect with the antenna feed line.

4. The RF front-end apparatus of claim 1, wherein the switch is one of a single-pole double-throw (SPDT) switch and a single-pole single-throw (SPST) switch.

5. The RF front-end apparatus of claim 1, wherein the detector comprises:
a coupler in a transmission signal path, for coupling a signal propagating in the transmission signal path; and
a signal detector for generating a transmission on/off signal indicating the presence or absence of a transmission signal according to a power level of the coupled signal received from the coupler and providing the transmission on/off signal to the switch controller.

6. The RF front-end apparatus of claim 5, wherein upon receipt of the transmission on signal from the signal detector, the switch controller turns off the switch.

7. The RF front-end apparatus of claim 5, wherein the coupler is installed at one of a baseband end, an intermediate (IF) end, and an RF end.

8. The RF front-end apparatus of claim 1, wherein the detector comprises:
a coupler in a signal path at a rear end of the circulator, for coupling a transmission signal and a received signal propagating in the signal path; and
a signal detector for calculating a power ratio between the coupled transmission and received signals, comparing the power ratio with a predetermined threshold, and if the received signal is the reflected wave of the transmission signal, providing a voltage standing wave ratio (VSWR) alarm signal to the switch controller.

9. The RF front-end apparatus of claim 8, wherein upon receipt of the VSWR alarm signal from the signal detector, the switch controller turns off the switch.

10. A radio frequency (RF) front-end apparatus in a time division duplex (TDD) wireless communication system, comprising:
a coupler in a transmission signal path, for coupling a signal propagating in the transmission signal path;
a signal detector for generating a transmission on/off signal indicating the presence or absence of a transmission signal according to a power level of the coupled signal received from the coupler;
a switch controller for generating a control signal based on the transmission on/off signal received from the signal detector and a switch on/off signal received from a control board; and
a switch at an input port of a low-noise amplifier (LNA), for switching on/off according to the control signal received from the switch controller.

11. The RF front-end apparatus of claim 10, wherein the switch is one of a single-pole double-throw (SPDT) switch and a single-pole single-throw (SPST) switch.

12. The RF front-end apparatus of claim 10, wherein upon receipt of the transmission on signal from the signal detector, the switch controller turns off the switch.

13. The RF front-end apparatus of claim 10, wherein the coupler is installed at one of a baseband end, an intermediate (IF) end, and an RF end.

14. A radio frequency (RF) front-end apparatus in a time division duplex (TDD) wireless communication system, comprising:
a detector at a predetermined position in a signal path, for calculating a voltage standing wave ratio (VSWR), comparing the VSWR with a predetermined threshold, and generating a VSWR alarm signal;
a switch controller for generating a control signal based on the signal received from the detector and a switch on/off signal received from a control board; and
a switch at an input port of a low-noise amplifier (LNA), for switching on/off according to the control signal received from the switch controller.

15. The RF front-end apparatus of claim 14, further comprising a circulator for providing a signal received from a power amplifier to an antenna feed line and a signal received from the antenna feed line to the switch, wherein the detector is installed in a signal path at a rear end of the circulator.

16. The RF front-end apparatus of claim 14, the switch is a single-pole double-throw (SPDT) switch.

17. The RF front-end apparatus of claim 14, the switch is a single-pole single-throw (SPST) switch.

18. The RF front-end apparatus of claim 14, wherein upon receipt of the VSWR alarm signal from the detector, the switch controller turns off the switch.
